(19) United States
(12) Patent Application Publication
(10) Pub. No.: US 2013/0075513 A1
(43) Pub. Date: Mar. 28, 2013

(54) ROLLING MILL COIL FORMING LAYING HEAD WITH PATH OR PIPE HAVING DISSIMILAR MATERIALS COMPOSITE CONSTRUCTION

(71) Applicant: Keith Fiorucci, Sturbridge, MA (US)

(72) Inventor: Keith Fiorucci, Sturbridge, MA (US)

(73) Assignee: SIEMENS INDUSTRY, INC., Alpharetta, GA (US)

(21) Appl. No.: 13/532,091

(22) Filed: Jun. 25, 2012

Related U.S. Application Data
(60) Provisional application No. 61/539,069, filed on Sep. 26, 2011.
(60) Provisional application No. 61/539,014, filed on Sep. 26, 2011.
(60) Provisional application No. 61/539,062, filed on Sep. 26, 2011.
(60) Provisional application No. 61/540,590, filed on Sep. 29, 2011.
(60) Provisional application No. 61/540,617, filed on Sep. 29, 2011.
(60) Provisional application No. 61/540,609, filed on Sep. 29, 2011.
(60) Provisional application No. 61/540,602, filed on Sep. 29, 2011.
(60) Provisional application No. 61/540,798, filed on Sep. 29, 2011.

(51) Int. Cl. B21C 47/08; B23P 11/00; B23P 17/04

(52) U.S. Cl. 242/361; 29/592; 29/428

(57) ABSTRACT

A rolling mill coil-forming apparatus includes a rotating quill that discharges elongated material into an elongated path hollow structure, such as a laying head pipe. The elongated structure is constructed of combinations of ferrous and non-ferrous dissimilar materials. Generally, non-ferrous materials are used in zones that are subject to relatively higher wear. A portion of the elongated path structure can be formed from nested, enveloping layers and/or by joining segments in axial abutting relationship. Components formed from nested layers can be constructed in many three dimensional compound curve shapes that can replicate the smooth, continuous curve elongated material transport path laying head pipes, with localized symmetrical or asymmetrical cross sections.

### CROSS-REFERENCE TO RELATED APPLICATIONS

This application claims priority under 35 U.S.C. §119(e) to co-pending U.S. Provisional Application Ser. Nos.: 61/539,014, 61/539,062, and 61/539,069, filed 26 Sep. 2011; and U.S. Provisional Application Ser. Nos.: 61/540,590; 61/540,602; 61/540,609; 61/540,617; and 61/540,798; filed 29 Sep. 2011, and all of which are entirely incorporated herein by reference as if fully set forth below.

### BACKGROUND

1. Field

Embodiments of the present invention relate to rolling mill coil-forming apparatuses, often referred to as laying heads, and more particularly to replaceable laying head pathways, such as laying head pipes, in laying heads.

2. Description of the Prior Art

Rolling mill coil-forming laying head apparatuses form moving rolled elongated material into a series of helical continuous loop rings. Those rings may be further processed downstream by bundling them into coils of the helical turns. Known laying heads are described generally in U.S. Pat. Nos. 5,312,065; 6,769,641; and 7,011,264, the entire contents of all of which are hereby incorporated by reference as if fully contained herein.

As described in these patents, rolling mill laying head systems comprise a quill, pipe support and a laying head pipe. The quill and pipe support are adapted to rotate the laying head pipe such that it can receive elongated material into its entry end. The laying head pipe has a curved intermediate portion that is surrounded by the quill's flared section and an end portion that projects radially outwardly from and generally tangential to the quill's rotational axis. The rotating quill and the laying head pipe in combination conform the rolled material into a helical curved shape. The laying head pipe may be replaced with one of a different profile and/or diameter in order to reconfigure the laying head to accommodate different dimensioned rolled material or to replace worn pipes.

Further helical profiling of the rolled material is accomplished in a rotating helical guide that includes troughs for receiving the rolled material about its outer circumference. The helical guide described in U.S. Pat. No. 6,769,641 is of segmented, sector-shaped, modular rim construction with the circumferential troughs formed within the rim sectors.

A generally annular ring or shroud, also commonly referred to as an end ring or guide ring, has a guide surface that circumscribes the laying head pipe discharge end and helical guide, so that the elongated material is confined radially as it is discharged in now fully coiled configuration to a conveyor for subsequent bundling and other processing. A pivoting tripper mechanism, including one or more tripper paddles, may be positioned at approximately the six o'clock or bottom position of the end ring/shroud distal the quill. Varying the pivot attack angle of the tripper mechanism relative to the ring/shroud inner diameter surface is useful to control elongated material coiling, for example to compensate for varying elongated material plasticity thickness, composition, rolling speed and cross sectional structure.

Laying Head Pipe Design and Operational Constraints

As previously noted the hollow laying head pipe in combination with the rotating quill and pipe support, conform the rolled material into a helical curved shape. Typically the laying head pipe is formed from a continuous length of symmetrical steel pipe or steel tubing that is bent in a forming jig by application of external heat and mechanical force to conform to the desired generally helical profile. Steel pipe or tubing is generally chosen for construction of laying head pipes for relative ease of workability into the desired final generally helical shape and relatively low material purchase cost. But commercial steel pipe or tubing have relatively low hardness: an undesirable limiting factor for rolling mill operation, productivity and maintenance.

Elongated material that is advancing at speeds up to approximately 500 feet/second (150 m/sec) is received in the laying head system intake end and discharged in a series of continuous coil loops at the discharge end. At such speeds, the hot rolled products exert a punishing effect on the laying head pipes, causing internal pipe surfaces to undergo rapid localized frictional wear and premature failure. Also, as the laying head pipes wear, their ability to deliver a stable ring pattern to the looped coil receiving conveyor at the discharge end of the laying head deteriorates. Unstable ring patterns disturb cooling uniformity and also contribute to coiling mishaps commonly referred to as “cobbling.”

For a number of years, it has been well accepted that laying head pipes with reduced bore sizes provide a number of significant advantages. By radially constricting the hot rolled products within a smaller space, guidance is improved and the ring pattern delivered to the cooling conveyor is more consistent, making it possible to roll at higher speeds. Unfortunately, however, these advantages have been offset to a large extent by significantly accelerated pipe wear due to the higher speed of the product. Also, the reduced bore size pipe can only be used with small diameter products, so it must be replaced by a larger bore size pipe for coiling of larger diameter products.

Frequent and costly mill shutdowns and preventive maintenance are required to replace prematurely worn laying head pipes and to address problems associated with elongated material cobbling. If a laying head pipe becomes so worn that it suffers a pipe wall rupture, the cobbling mishap can impact elongated material feed upstream of the laying head. From a wear resistance point of view it is desirable to form the laying head pipe inner wear surface from relatively hard low surface friction steel and further desirable to perform further surface hardening and heat treatment, but such wear treatment steps must be balanced with ease and cost of pipe fabrication,

Thus, in the past, those skilled in the art have deemed it necessary to compromise laying head pipe design and performance by employing larger bore laying head pipes and rolling at reduced speeds below the rated design speeds of the mills. The combination of larger than desired laying head pipe internal diameter and reduced rolling speeds have been implemented in order to schedule preventive maintenance pipe replacement during scheduled maintenance “downtime”. Conventional and current laying head pipes must be replaced after processing quantities of elongated material of approximately 3,000 tons or less, depending on diameter, speed and product composition.

Those skilled in the art have made repeated attempts at increasing the useful life of laying head pipes for larger total processing tonnage, so that more elongated material can be processed before replacement. For example, as disclosed in U.S. Pat. Nos. 4,074,553 and 5,839,684, it has been proposed to line the laying head pipes with wear resistant insert rings that are inserted into an external laying head pipe casing. Adjoining rings within curved sections of the laying head pipe casing have discontinuity gaps that are not desirable for smooth advancement of elongated material that is being transported within the laying head pipe. U.S. Pat. No. 6,098,909 discloses a different approach where the laying head pipe is eliminated in favor of a guide path defined by a spiral groove in the outer surface of a conical insert enclosed by a conical outer casing, with the insert being rotatable within the outer casing to gradually shift the wear pattern on the inner surface of the outer casing. It is not believed that the spiral groove conical insert approach is readily compatible with all existing quill laying heads that presently incorporate laying head pipe structures.

Attempts have also been made at carburizing the interior laying head pipe surfaces in order to increase hardness and resistance to wear. However, the carburizing process requires a drastic quenching from elevated processing temperatures, which can distort the pipe curvature. The carburized layer has also been found to be relatively brittle and to temper down at elevated temperatures resulting from exposure to the hot rolled products.

The owner of this patent application has also disclosed the application of a boronized layer to the laying head pipe wear surfaces by subjecting them to a thermochemical treatment in which boron atoms are diffused into the pipe interior to increase its hardness. See Patent Cooperation Treaty Application entitled “Boronized Laying Pipe”, filed in the United States Receiving Office on Sep. 2, 2011, Serial No. PCT/US2011/050314.

The owner of this patent application has also disclosed a laying head pipe having inner and outer friction-tight engaged concentric layers in which the inner layer advances axially relative to the outer layer during laying head operation due to centrifugal forces, differences in localized thermal expansion, and thermal cycling between the layers. Thus worn sections of the laying head pipe interior advance along the pipe interior so that a “fresh” unworn surface continually replenishes the worn section. See Patent Cooperation Treaty Application entitled “Regenerative Laying Pipe”, filed in the United States Receiving Office on Sep. 2, 2011, Serial No. PCT/US2011/050283.

### SUMMARY

Briefly described, embodiments of the present invention relate to a rolling mill coil-forming apparatus laying head path structure, for retention and transport of elongated materials in a laying head, so that the elongated material can be selectively coiled. The laying head path structure may perform the functionality of a conventional laying head pipe, In aspects of the present invention, the laying head path structure comprises combinations of ferrous and non-ferrous dissimilar materials. Non-ferrous materials can be used in zones that are subject to relatively higher wear, and ferrous materials, such as steel, can be used in zones that are subject to relatively less wear. Alternatively, an entire laying head path structure can be fabricated from one or more non-ferrous materials in a single layer or in two or more nested multiple layers. In this manner, a substantial portion of the laying head path structure can be formed from one or more sections of steel pipe: a cost effective material in which there is fabrication familiarity in the art. Zones, such as for example high-wear zones, can be fabricated from relatively harder, more expensive material, and/or material that is relatively more difficult to fabricate into laying head path pipes than traditionally used steel.

Portions of the laying head path structure or its entirety can be formed from nested, enveloping layers by inserting one or multiple layers of pipe or other elongated hollow structure, including combinations of dissimilar metals, into each other: i.e., forming a nested structure of two or more layers. Similarly, portions of the laying head path structure or its entirety can be formed from adjoining, abutting segments that form a continuous inner diameter surface for passage and transport of elongated material therethrough. The abutting segments may be spliced or otherwise coupled to each other by mating interlocking ends, fasteners or by permanent joining them together (e.g., by welding). The adjoining segment portions may be nested within or circumscribe another pipe to form a laying head path with multiple layers. Components formed from dissimilar nested layers or abutting sections can be constructed in three dimensional compound curve shapes that can replicate the smooth, continuous curve elongated material transport path of known laying head pipes, or other desired laying head pathway devices.

The fabricated layered and/or segmented structures facilitate formation of zones within the component, such as including by way of example wear-resistant zones or friction reducing zones in the layer that is in direct contact with the elongated material. In the case of multi-layer laying head paths the innermost layer can be a regenerative layer that advances downstream the same direction as the elongated material, so that the upstream portion within a laying path internal wear zone constitutes a fresh, unworn surface.

Another exemplary embodiment relates to a coil-forming apparatus laying head system for coiling hot rolled elongated material, comprising a quill rotating about an axis, for discharging elongated material. A support is coaxial with the quill rotational axis. An elongated transport path hollow member, such as a laying head pipe, is coupled to the support, for passage of elongated material there through. The hollow member comprises a first end generally aligned with the quill rotational axis for receiving elongated material discharged from the quill, and a second end radially spaced from the rotational axis for discharging elongated material generally tangentially relative to the rotational axis. The hollow member can be constructed of combinations of ferrous and non-ferrous dissimilar materials. Non-ferrous materials can be used in zones that are subject to relatively higher wear, and ferrous materials, such as steel, can be used in areas that are subject to relatively less wear. Components formed from dissimilar nested layers or abutting sections can be constructed in three dimensional compound curve shapes that can replicate the smooth, continuous curve elongated material transport path of known laying head pipes, or other desired laying head transport paths.

An additional exemplary embodiment of the present invention relates to a method for forming portions of the laying path structure with dissimilar metals by nesting and enveloping layers and/or axially abutting and joining sections, and then forming the nested composite structure into the desired three dimensional curved shape of a laying head path. Additionally or alternatively pre-formed curved sections may be joined axially to form a portion or all of the composite structure. In this method, ferrous metals or other relatively inexpensive material often form a substantial portion of the laying head path and relatively more expensive non-ferrous metals are used in zones that are generally subject to higher wear rates within the laying head pipe.

The features of aspects of the present invention may be applied jointly or severally in any combination or sub-combination by those skilled in the art. Further features of aspects and embodiments of the present invention, and the advantages offered thereby, are explained in greater detail hereinafter with reference to specific embodiments illustrated in the accompanying drawings, wherein like elements are indicated by like reference designators.

### BRIEF DESCRIPTION OF THE DRAWINGS

The teachings of the present invention can be readily understood by considering the following detailed description in conjunction with the accompanying drawings, in which:

FIG. 1 shows a side elevational view of a coil-forming apparatus laying head system, in accordance with an exemplary embodiment of the present invention;

FIG. 2 shows a top plan view of the laying head system of FIG. 1, in accordance with an exemplary embodiment of the present invention;

FIG. 3 shows a sectional elevational view of the laying head system of FIG. 1, including its end ring and tripper mechanism, in accordance with an exemplary embodiment of the present invention;

FIG. 4 shows an elevational view of the discharge end of the laying head system of FIG. 1, including its end ring and tripper mechanism, in accordance with an exemplary embodiment of the present invention;

FIG. 5 shows a known construction laying head transport path/pipe and typical exemplary wear zones experienced during laying head operation;

FIG. 6 shows a perspective view of a laying head elongated material transport path pipe, in accordance with an exemplary embodiment of the present invention;

FIG. 7 shows a partially cut away axial cross-sectional view of the laying head pipe of FIG. 6;

FIG. 8 shows a radial cross-sectional view of the laying head pipe of FIGS. 6 and 7, taken along 8-8 thereof;

FIG. 9 shows a partial cut away axial cross-sectional view of a laying head pipe, in accordance with another exemplary embodiment of the present invention;

FIG. 10 shows a radial cross-sectional view of the laying head pipe of FIG. 9, taken along 10-10 thereof;

FIG. 11 shows a side elevational view of a laying head pipe, in accordance with an another exemplary embodiment of the present invention;

FIG. 12 shows a partial cut away axial cross-sectional view of the laying head pipe of FIG. 11;

FIG. 13 shows a radial cross sectional view of the laying head pipe of FIG. 11, taken along line 13-13 thereof;

FIG. 14 shows a partial axial cross-sectional view of the laying head pipe of FIG. 11;

FIGS. 15A-15C are diagrammatic depictions illustrating the forces acting on a laying head pipe in accordance with embodiments of the present invention during heating and cooling cycles;

FIG. 16 a perspective view of a laying head pipe, in accordance with yet another exemplary embodiment of the present invention;

FIG. 17 shows a partially cut away axial cross-sectional view of the laying head pipe of FIG. 16, in accordance with an exemplary embodiment of the present invention; and

FIG. 18 shows a partially cut away perspective view of the laying head pipe of FIG. 16, in accordance with an exemplary embodiment of the present invention.

To facilitate understanding, identical reference numerals have been used, where possible, to designate identical elements that are common to the figures.

### DETAILED DESCRIPTION

After considering the following description, those skilled in the art will realize that the teachings of the present invention can be utilized in rolling mill coil-forming apparatus laying heads and more particularly to laying head elongated transport path pipes or other equivalent elongated structures for laying heads. Aspects of the present invention facilitate longer laying head path service life so that more tons of elongated material can be processed by the laying head before preventative maintenance replacement. For example, it is possible to increase the laying head elongated material processing speed so that more tons of elongated material can be processed in a production shift without undue risk of laying head path/pipe failure.

Laying Head System Overview

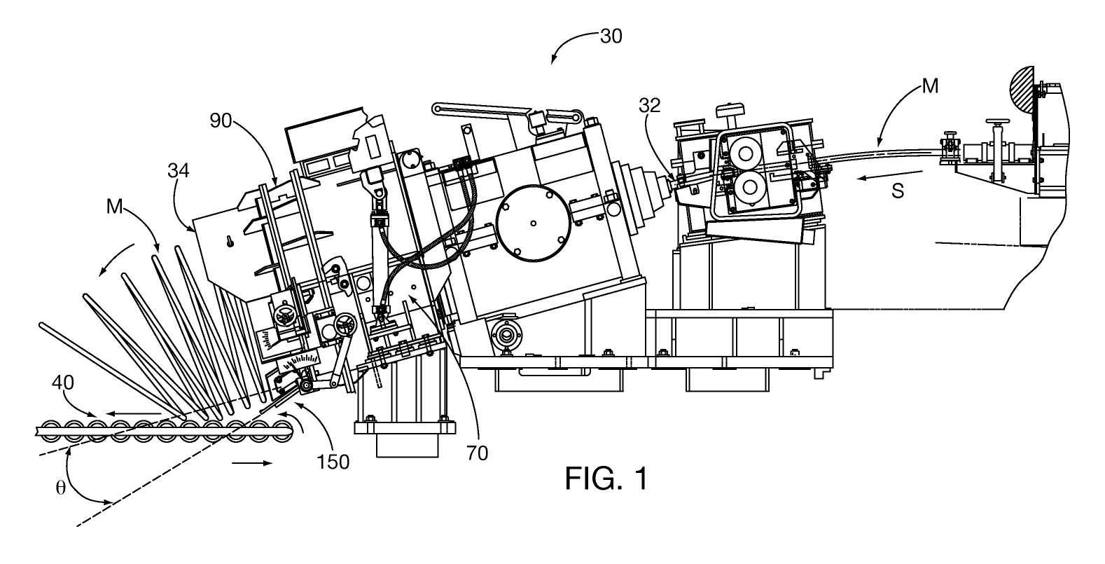

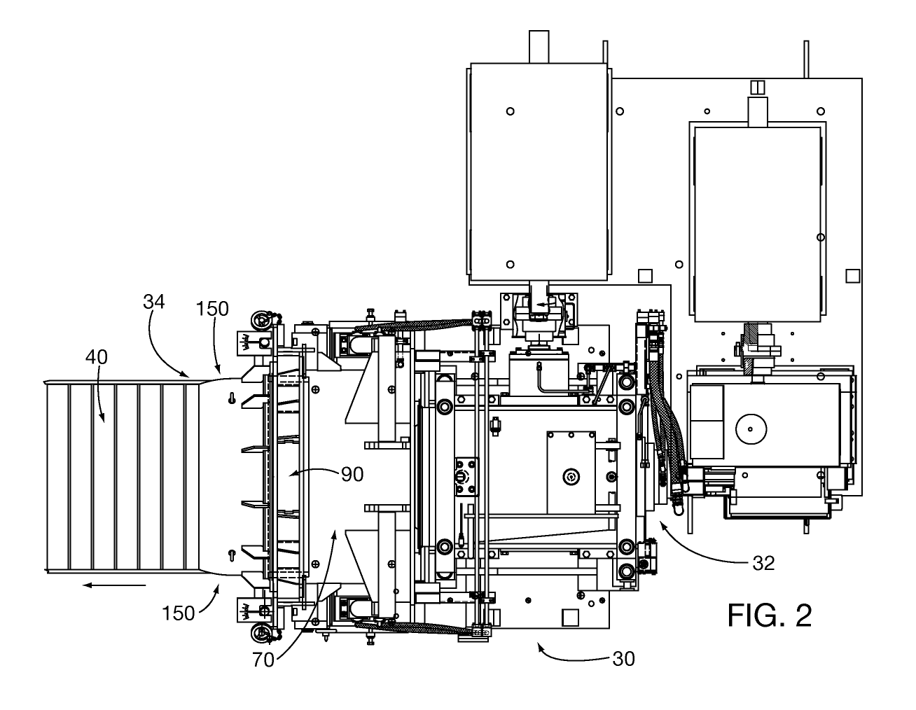

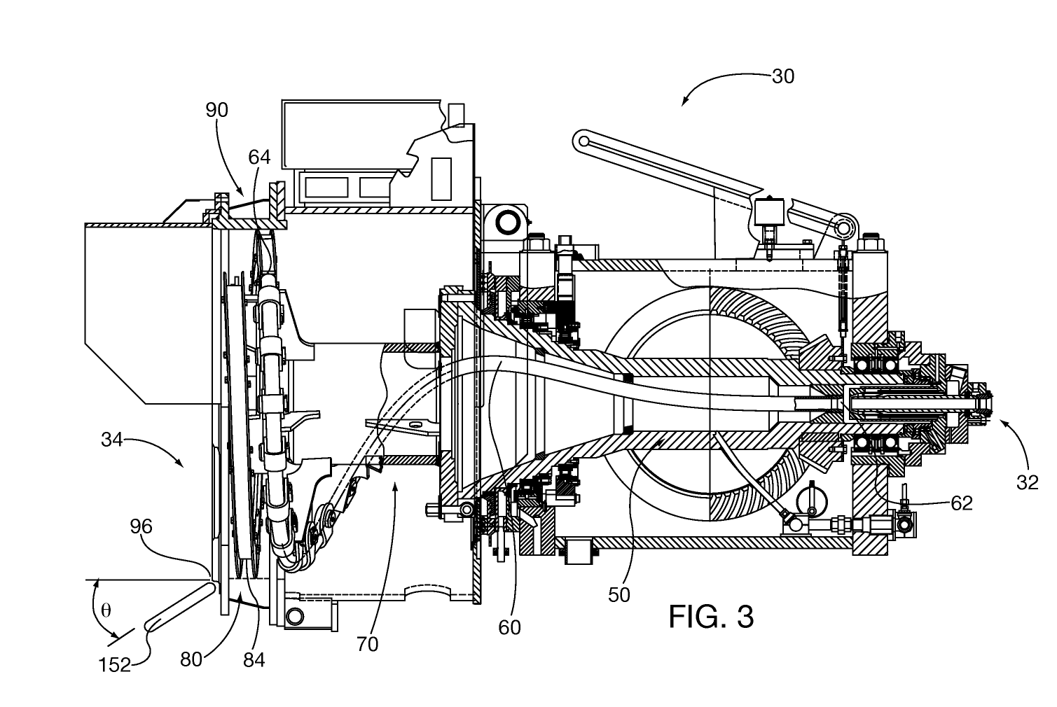

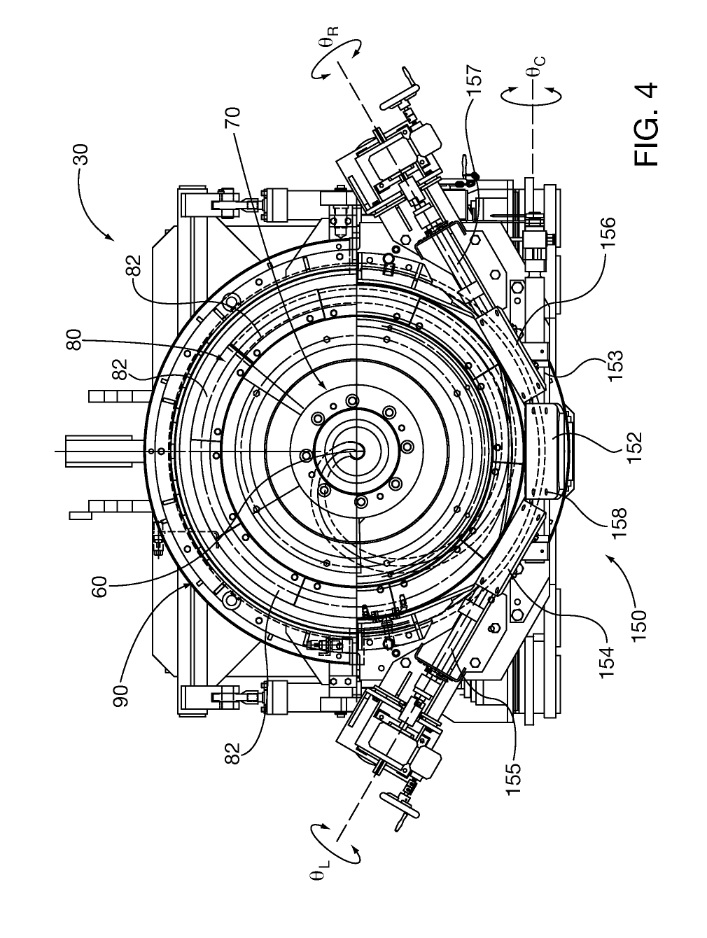

Referring generally to FIGS. 1-4, the coil-forming apparatus laying head system coils rolled elongated material M, such as for example hot rolled steel rebar. Elongated material M that is advancing at speed S, which may be as high as or greater than approximately 500 feet/second (150 m/sec), is received in the laying head system 30 intake end 32 and discharged in a series of continuous coil loops at the discharge end 34, whereupon the coils are deposited on a conveyor 40.

The laying head system 30 comprises a rotatable quill 50, a path 60 and a pipe path support 70. The path 60 defines a hollow elongated cavity to enable transport of the material M. Aspects of the present invention allow the path to comprise a laying head pipe; indeed, the path 60 may occasionally be referred to as a laying head pipe herein.

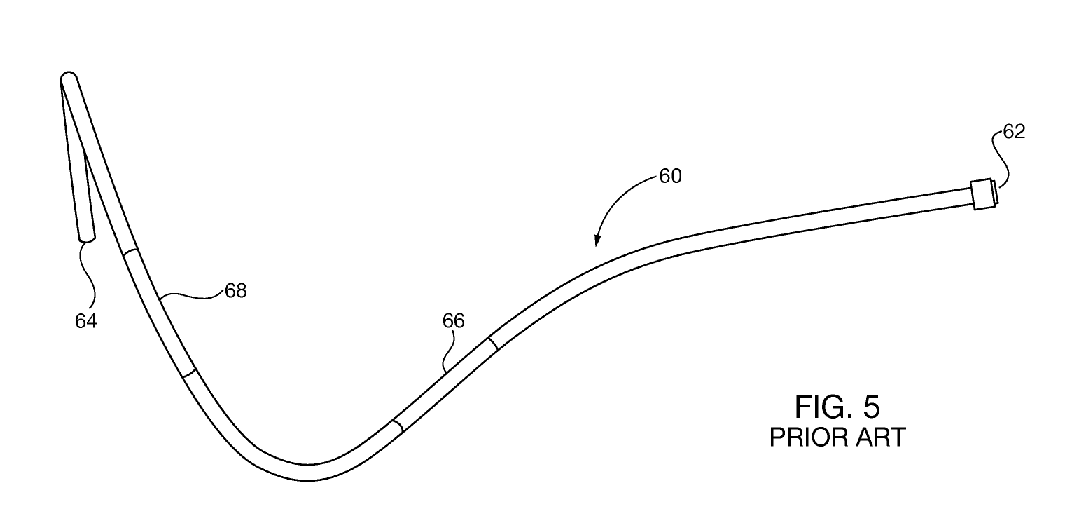

The quill 50 can have a generally horn shape that is adapted to rotate about an axis. The path 60 has a generally helical axial profile of increasing radius, with a first end 62 that that is aligned with the rotational axis of quill 50 and receives elongated material M. The path 60 has a second end that is spaced radially outwardly from and generally tangential to the quill 50 rotational axis and thus discharges the elongated material generally tangentially to the periphery of the rotating quill. The path 60 is coupled to a pipe support 70 that is in turn coupled coaxially to the quill 50, so that all three components rotate synchronously about the quill rotational axis. Quill 50 rotational speed is selected based upon, among other factors, the elongated material M structural dimensions and material properties, advancement speed S, desired coil diameter and number of tons of elongated material that can be processed by the laying head pipe without undue risk of excessive wear. FIG. 5 shows conventional laying head path/pipe 60 wear zones 66, 68 in which the pipe interior is subjected to relatively higher wear rates than other portions of the pipe. Aspects of the present invention address the higher wear rates by locally hardening the zones 66, 68 and other portions or all other desired zones. If desired the entire or equivalent elongated structure can be hardened by application of aspects of the present invention.

In this embodiment, as elongated material M is discharged from the second end 64, it is directed into a ring guide 80 having guide rim segments 82 into which are formed a guide trough channel 84 having a helical pitch profile, such as that described in commonly owned U.S. Pat. No. 6,769,641. As the elongated material M is advanced through the ring guide 80 it is continued to be conformed into a continuous

As stated in the '641 patent, the segmented ring guide enables relatively easy reconfiguration of the ring guide helical diameter to accommodate different elongated materials by changing the rim segments 82 without disassembling and replacing the entire ring guide 80.

As previously noted, the elongated material M is configured into a continuous looped coil as it rides within the ring guide 80 helical trough channel 84. Ring guide 80 is coupled to the pipe support 70 and rotates coaxially with the quill 50. The helical trough 84 advancement rotational speed is harmonized with the elongated material Ni advancement speed S, so there is little relative linear motion speed between the two abutting objects and less rubbing wear of the trough 84 surfaces that contact the coiling material.

Stationary end ring 90 has an inner diameter that is coaxial with the quill 50 rotational axis and circumscribes the laying path/pipe 60 second end 62 as well as the ring guide 80. The end ring 90 counteracts centrifugal force imparted on the elongated material M as it is discharged from the laying head pipe 60 second end 62 and advances along the ring guide 80 helical trough channel 84 by radially restraining the material within the end ring inner diameter guide surface. High relative speed between the advancing elongated material Ni and the stationary end ring 90 causes rubbing wear on the end ring inner diameter guide surface.

Referring to FIG. 1, elongated material M that is discharged from the coil-forming apparatus laying head system 30 falls by gravity in continuous loops on roller conveyor 40, aided by the downwardly angled quill rotational axis at the system discharge end 34. Tripper mechanism 150 pivots about an axis abutting the distal axial side of the end ring 90 guide surface. That pivotal axis is generally tangential to the end ring 90 inner diameter guide surface about a pivotal range of motion Θ. As is known, coiled material M coiling characteristics and placement on the conveyor 40 can be controlled by varying the pivotal angle Θ.

Path Fabrication

Embodiments of the present invention include a rolling mill laying head path structure, for retention and transport of elongated materials in a laying head, so that the elongated material can be selectively coiled. Any portion of the path structure in its entirety is formed from nested, enveloping layers and/or axially abutting segments within a layer. Portions of layers and/or segments are constructed of dissimilar ferrous and non-ferrous materials, with the latter generally being used in zones that are subject to greater wear during laying head operation. An entire laying head pipe or equivalent elongated structure can be fabricated entirely from one or more non-ferrous materials in a single layer or in two or more nested multiple layers. Laying head components formed from dissimilar nested layers and/or adjoining segments in a layer can be constructed in any three dimensional compound curve shape that can replicate the smooth, continuous curve elongated material transport path of known laying head pipes, or any other desired path. The fabricated structures facilitate formation of zones within the component, such as including by way of example wear-resistant zones or friction reducing zones. The zones can be formed during the path laying head pipe fabrication process, such as by inserting pipes constructed of different material into each other or by abutting sections of different materials next to each other in a given layer.

Any portion of the path or the structure in its entirety can be formed from adjoining, abutting segments of the same or dissimilar material that form a continuous inner surface for passage and transport of elongated material therethrough. The abutting segments may spliced or otherwise coupled to each other by mating interlocking ends, fasteners and permanent joining (e.g., by welding). The adjoining segment portion may be nested within or circumscribe another pipe so that the composite structure has more than one layer thickness, and may be used in a structure having more than two nested layers.

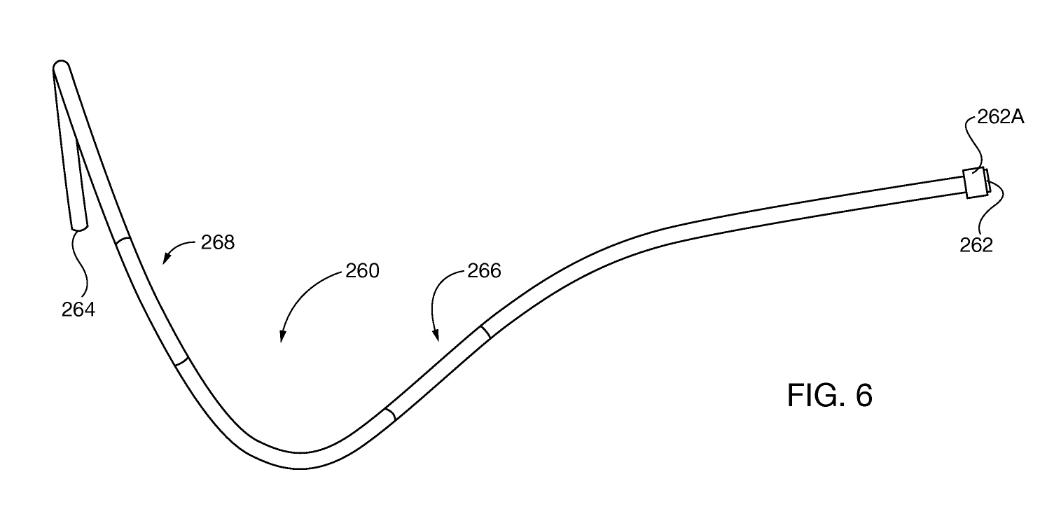

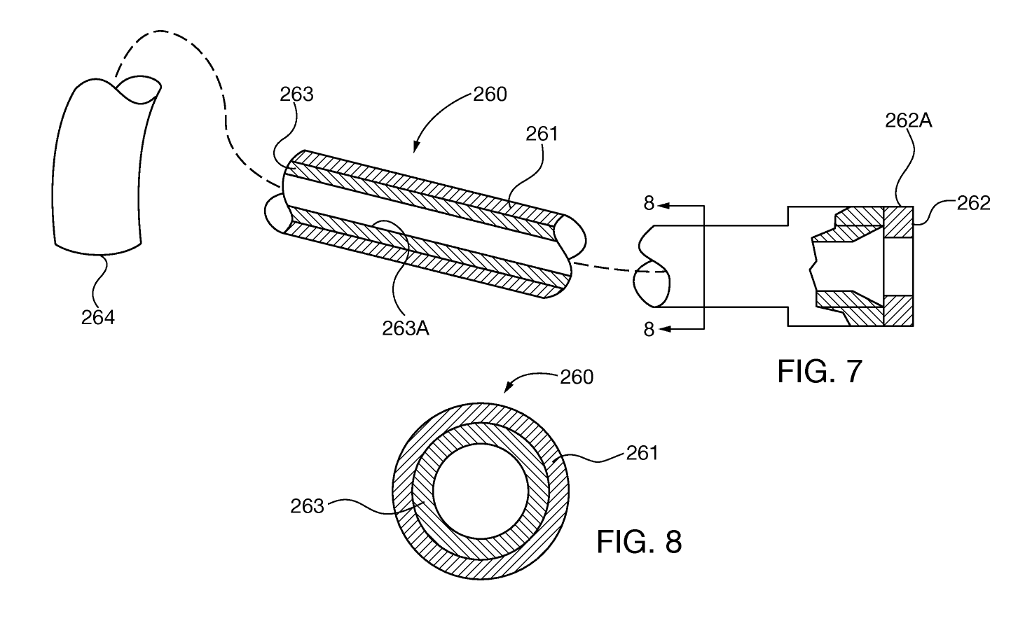

FIGS. 6-8 show a laying head path 260 that has a generally cylindrical outer profile conforming to known laying head pipes, for direct substitution in a known laying head such as the one shown in FIGS. 1-5. Laying head path 260 has a first intake end 262 with an annular retaining collar 262A and a second discharge end 264. The laying head path 260 is a composite structure fabricated from nested subcomponents including an outer steel pipe or tube 261 and an inner pipe or tube 263 formed from a harder non-ferrous material, such as stainless steel or tungsten carbide. The inner layer 263 has a continuous inner surface 263A for contact with elongated material that is transported through the laying head pipe. The inner surface 263A may be surface coated or treated to harden the surface or provide a friction reducing zone that may include a solid lubricant such as graphite.

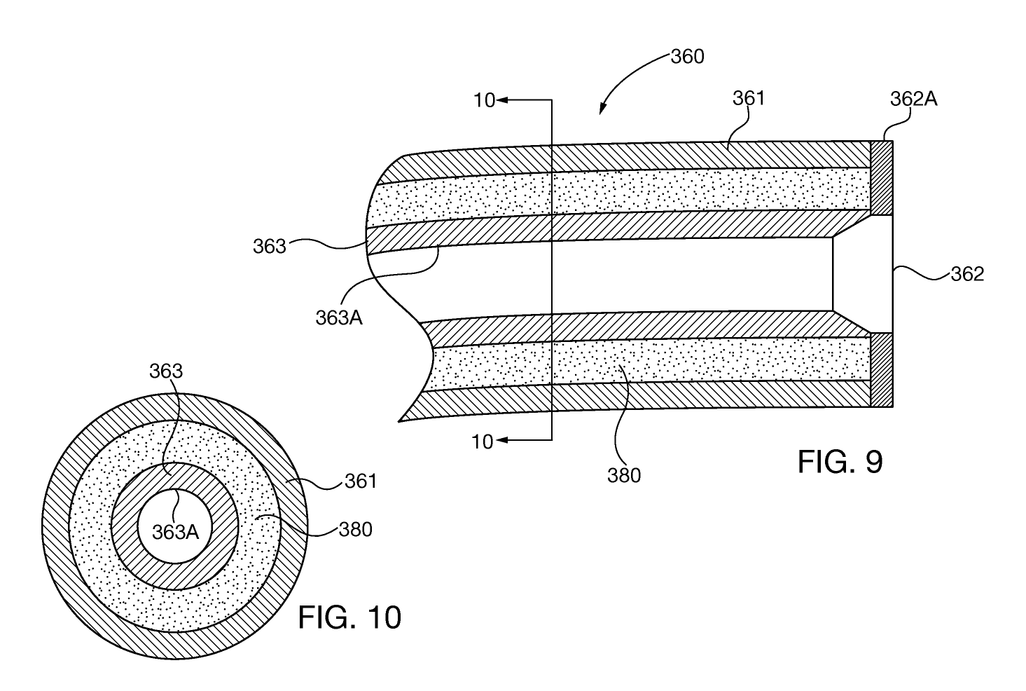

FIGS. 9 and 10 show another embodiment of the laying head path 360 of the present invention that has a first intake end 362 with an annular retaining collar 362A. The laying head path 360 is a composite structure fabricated from nested subcomponents including an outer steel pipe or tube 361 and an inner pipe or tube 363 formed from tungsten carbide tubing or tungsten carbide sintered to form a generally tubular hollow structure. The inner tube 363 has a continuous inner surface 363A for contact with elongated material that is transported through the laying head path. The inner surface 363A may be surface coated or treated to harden the surface or provide a friction reducing surface. An optional insulating high temperature grout layer 380 may be interposed between the outer pipe 361 and the inner pipe 363.

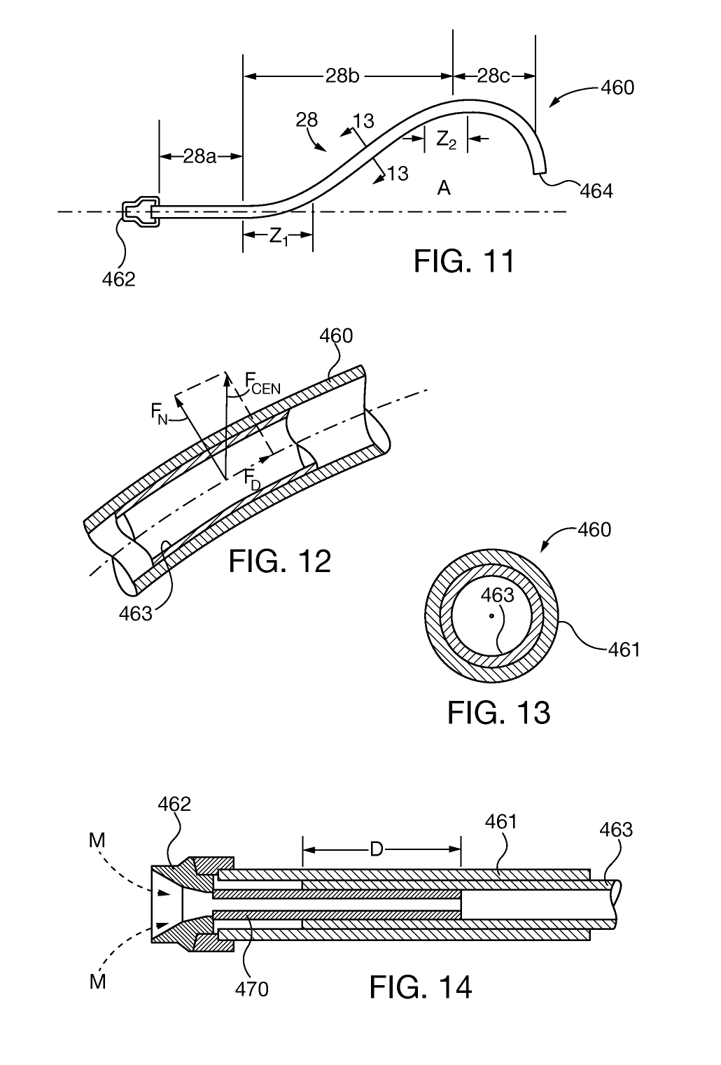

As shown and described in commonly owned Patent Cooperation Treaty Application entitled “Regenerative Laying Pipe”, filed in the United States Receiving Office on Sep. 2, 2011, Serial No. PCT/US2011/050283, a laying head pipe having inner and outer friction-tight engaged concentric layers in which the inner layer advances axially relative to the outer layer during laying head operation due to centrifugal forces, differences in localized thermal expansion, and thermal cycling between the layers. Thus worn sections of the laying head pipe or other elongated laying head path interior advance along the pipe interior so that a “fresh” unworn surface continually replenishes the worn section. Specifically, referring to FIGS. 11-15C, the laying head pipe 460 in accordance with the present invention, has an outer tube or pipe 461, constructed from ferrous metal, such as steel, with that pipe having an entry section 462 aligned with axis A, an intermediate section 28b curving away from axis A, and a delivery section 28c having a radius measured from axis A.

An inner tube or pipe 463 has entry, intermediate and delivery sections respectively lining the entry, intermediate and delivery sections of the outer tube 461, and is constructed of non-ferrous material such as stainless steel or tungsten carbide. The inner tube 463 is constrained against movement relative to the outer tube 461 solely by frictional contact with the outer tube. It has been observed that in service, the internal surface of a laying head pipe 463A is prone to accelerated localized wear in zone Z, approximately at the junction of entry section 28a and intermediate section 28b, and again in zone Z₂ approximately at the junction between intermediate section 28b and the delivery section 28c. If left unchecked, this localized wear results in premature grooving of the interior pipe surface, followed by a breakthrough of the product through the wall of the laying head pipe.

In accordance with the present invention, this wear problem is addressed by lining the outer tube 461 with the inner tube 463, and by allowing the inner tube to be restrained against movement within the outer tube solely by frictional contact between their respective outer and inner surfaces.

When the laying head path laying head pipe 460 is in service, the inner tube 463 is heated by contact with the hot rolled product M. Typically, the hot rolled product will be at a temperature of about 900-110° C., which will result in a heating of the inner tube 463 to an elevated temperature of about 400° C. The outer tube will typically have a lower temperature due to its exposure to the surrounding atmosphere.

Additionally, as shown in FIG. 12, the intermediate section 28b of the laying head pipe will be subjected to a centrifugal force F_{CEN} as a result of its rotation about axis A. This force can be resolved into a force F_{N} normal to the guide path of the laying head pipe, and drive force F_{D} exerted towards the delivery end of the laying head pipe. Driving force F_{D} will be supplemented by an additional driving force exerted by the hot rolled product passing through the laying head pipe.

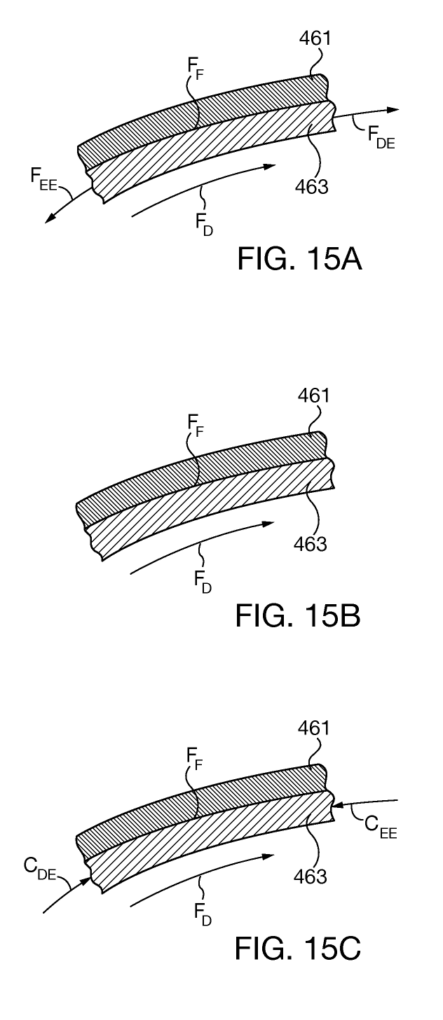

As shown in FIG. 15A, as the inner tube 463 is being heated by contact with the hot rolled product, it will undergo expansion, exerting forces in opposite directions towards the entry end (arrow F_{EE}) and the delivery end (arrow F_{DE}). The expansion forces F_{EE} and F_{DE} are sufficient to overcome the frictional resistance F_{F}. The expansion force F_{EE} is overcome by the sum of expansion force F_{DE} and the driving force F_{D}, resulting in the inner tube 463 being shifted incrementally within the outer tube 461 towards the delivery end of the outer tube.

As shown in FIG. 15B, when the temperature of the inner tube 463 stabilizes, there are no expansion or contraction forces. The frictional force F_{F} overcomes the driving force F_{D}, and the inner tube remains fixed within the outer tube.

As shown in FIG. 15C, when the inner tube 463 is cooled, it will undergo contraction, again exerting opposite forces towards the entry end (arrow C_{EE}) and the delivery end (arrow C_{DE}). The forces C_{EE} and C_{DE} are sufficient to overcome the frictional force F_{F}. The contraction force C_{EE} is overcome by the sum of contraction force C_{DE} and the driving force F_{D}, resulting in the entry end of the inner tube 463 being shifted incrementally within the outer tube 461 towards the delivery end 464 of the outer tube.

Thus, it will be seen that as the laying head path laying head pipe 460 undergoes heating and cooling cycles, the inner tube 463 will be shifted incrementally in one direction towards the delivery end 464 of the outer tube 461. This incremental shifting will change and thus renew the internal surfaces of the inner tube that are in frictional contact with the hot rolled product, and in so doing, will avoid prolonged frictional contact at any one given area. The axially overlapping nested configuration of the inner tube 463 and inner sleeve 470 compensates for axial advancement of the inner tube toward the delivery end 464, so that two nested pipe layers circumscribe the elongated material M.

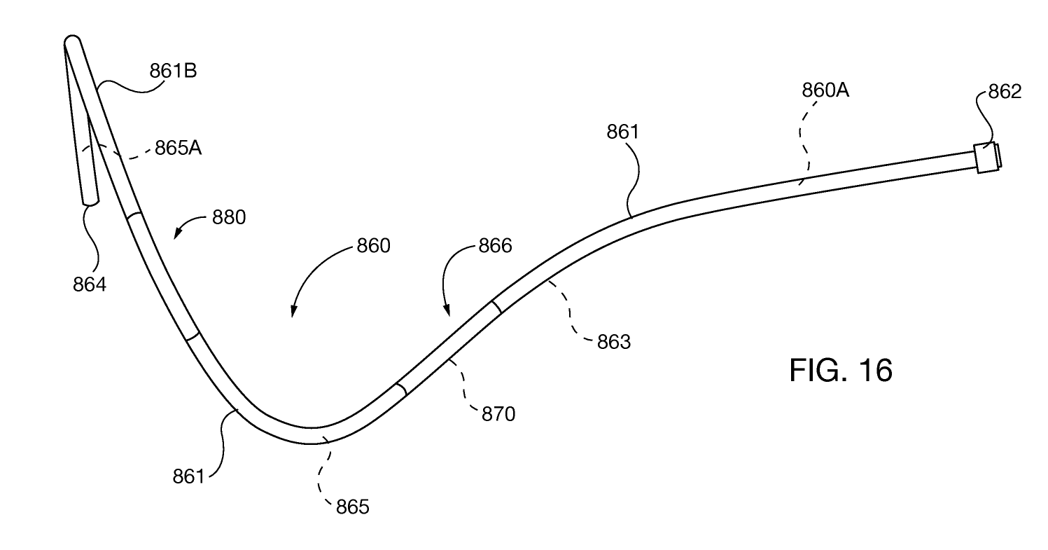

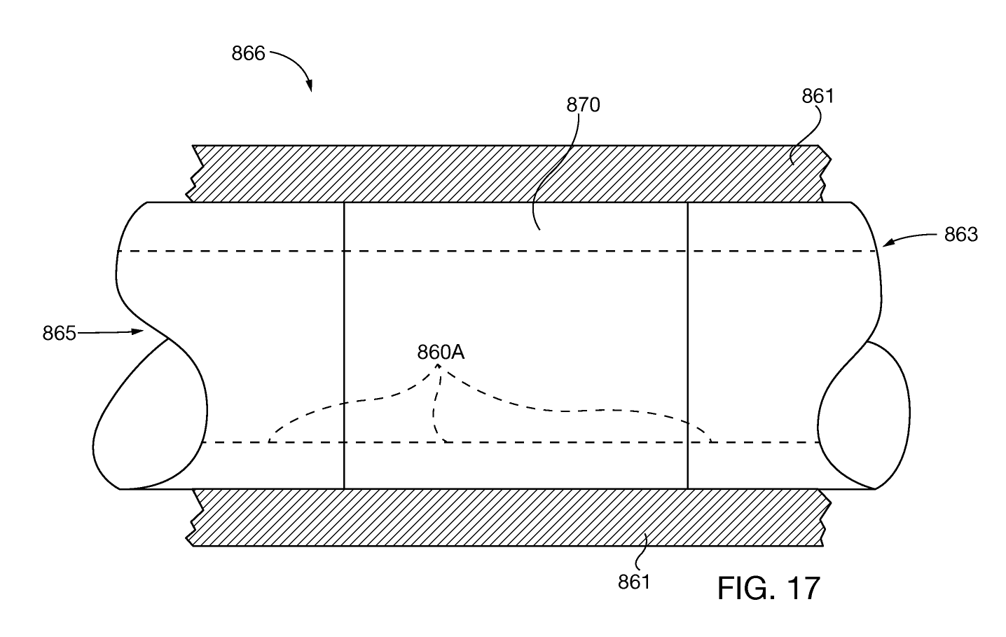

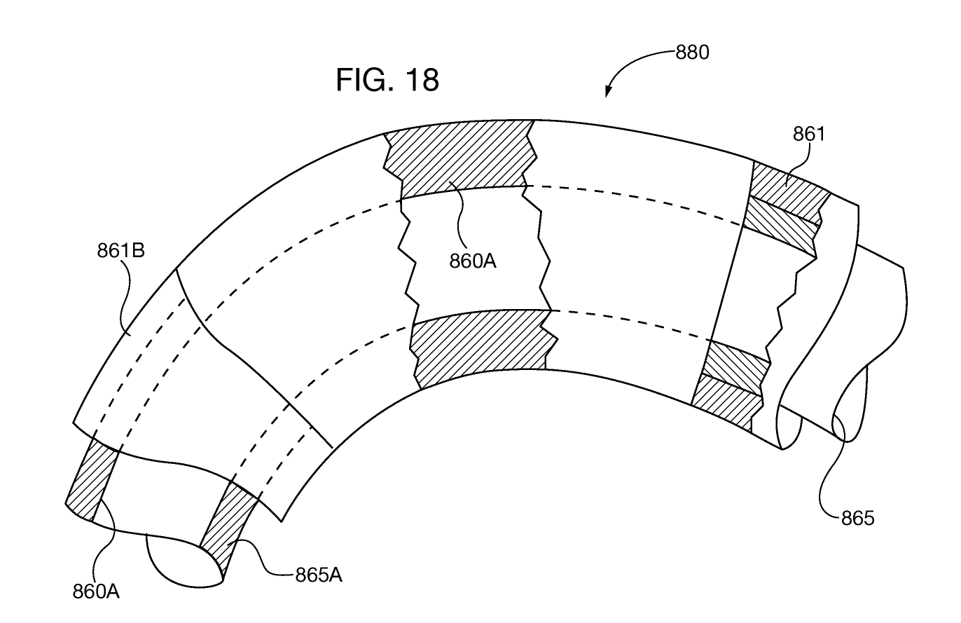

Any non-ferrous or ferrous material portion of a segmented, spliced laying head path elongated structure laying head pipe can be circumscribed and retained within an outer ferrous material pipe layer, and conversely such a segmented, spliced laying head path laying head pipe can circumscribe another pipe (ferrous or non-ferrous material) in layered fashion. If desired, an entire laying head pipe or equivalent elongated path structure can be fabricated entirety from one or more non-ferrous materials in a single layer or in two or more nested multiple layers. For example, if desired, an entire single layer path or pipe can be constructed from a non-ferrous material. In FIGS. 16-18 laying head path laying head pipe 860 has a first intake end 862 and a second discharge end 864 that defines a generally continuous surface 860A therein for passage of elongated material. The laying head path laying head pipe 860 is a composite structure fabricated from spliced adjoining subcomponents 861, 880 and 861B that form an outer concentric layer as well as a generally concentric pipe inner layer including sections 863, 870, 865 and 865A. Specifically with reference to a downstream flow direction from the intake end 862 to the discharge end 864, the outer layer of laying head pipe 860 has a steel outer pipe segment 861 that abuts against and is joined to a fabricated wear element 880, shown as a cast or sintered structure (for example sintered tungsten carbide) by a weld bead (not shown) and in turn to downstream steel pipe 861B. The laying head pipe 860 also has an inner nested layer, which again from intake end 862 to discharge end 864, includes an inner steel pipe 863 that abuts against a non-ferrous material wear insert 870 (formed for example from stainless steel tubing) and in turn abuts against inner layer steel pipe 865. Referring to FIG. 15 the steel pipe 865 abuts against fabricated wear element 880. Lastly inner layer steel pipe 865 abuts against the other downstream end of fabricated wear element 880. The inner segments 863, 870, 865 and 865A do not have to be rigidly coupled to each other because they are circumscribed by and captured within the outer pipe layers 861, 880 and 861B. While the inner segments 863, 870, 865 and 865A do not have to be rigidly coupled to each other, the inner surface can be effectively continuous, because gaps between adjoining sections are sufficiently smaller than the elongaged material diameter and circumference so that such gaps do not impede transport of the elongated material through the elongated structure laying head pipe 860.

For all laying head elongated path structures embodiments of the present invention herein, the laying path elongated structure may have a symmetrical or asymmetrical cross section, and can be fabricated in a series of adjoining sections The laying head elongate pathway inner diameter can be varied, such as by varying the wall thickness of the inner pipe, while if desired, maintaining the same outer pipe diameter. The inner and outer tubes or other elongated structure members 461 and 463 may be fabricated from various ferrous or non-ferrous materials, including ceramics, preferred examples comprising ferrous metals, nickel based alloys, cobalt based alloys and titanium based alloys, as well as deposited nano particle coatings of any of them. More specifically the outer pipe comprises any desired material or metal (steel often being a cost effective choice) or non-metallic structures, such as filament reinforced carbon fiber. The inner surface of a filament reinforced carbon fiber or other outer elongated path member/pipe may include an inner layer formed from a nano particle layer of non-ferrous material, such as stainless steel or tungsten carbide, deposited thereon. The deposited nano layer functions as the equivalent of a separate inner pipe pathway structure. The inner pipe or other functionally equivalent inner layer path forming structure is comprises ferrous or non-ferrous materials, including ceramic, nano particle material coatings, steel, or non-ferrous alloys such as stainless steel, tungsten carbide or so-called super alloys, such as for example Inconel®, Waspaloy® or Hastelloy®. Other non-ferrous metals may be substituted for the inner or outer pipe layers, comprising by way of example stainless steel, tungsten carbide, and so-called super alloys, such as for example Inconel®, Waspaloy® or Hastelloy®, ceramics or nano particle layers of the above. The inner surface of the inner tube that is in contact with the elongated material may be treated or coated (including nano particle coatings) to increase surface hardness, reduce friction or decrease thermal ablation.

Although various embodiments, which incorporate the teachings of the present invention, have been shown and described in detail herein, those skilled in the art can readily devise many other varied embodiments that still incorporate these teachings.

What is claimed is:

1. An apparatus for retention and transport of elongated materials in a rolling mill coil-forming laying head system comprising:
an elongated hollow pathway structure defining a continuous inner surface for transport of elongated materials therein, the inner surface including at least one non-ferrous material in at least one zone that is subjected to a relatively higher wear rate.

2. The apparatus of claim 1, the inner surface in the zone including one or more non-ferrous materials and other portions of the pathway including one or more ferrous materials.

3. The apparatus of claim 1, further comprising a non-ferrous inner layer in the zone that is captured by an outer layer.

4. The apparatus of claim 3, the outer layer material selected from the group consisting of ferrous and non-ferrous materials.

5. The apparatus of claim 3, the inner layer further comprising ferrous material abutting the non-ferrous material, with the abutting materials captured by the outer layer.

6. The apparatus of claim 5, further comprising an axial end collar affixed to the outer layer for capturing the inner layer therein.

7. The apparatus of claim 3, the non-ferrous inner layer and the outer layer are in circumferential friction contact with each other, with the inner layer advancing axially with respect to outer layer during repetitive heating and cooling cycles of the elongated pathway structure.

8. The apparatus of claim 7, the entire inner layer comprising non-ferrous material and outer the layer comprising ferrous or non-ferrous material.

9. The apparatus of claim 1, the zone inner surface is selected from the group consisting of hardened and friction reducing zones.

10. The apparatus of claim 1, the non-ferrous materials selected from group consisting of nickel based alloys, cobalt based alloys and titanium based alloys, stainless steel, tungsten carbide, ceramics, and superalloys.

11. The apparatus of claim 10, the non-ferrous materials included in a nano layer deposited on the inner surface.

12. A rolling mill coil-forming laying head system comprising:
a driven rotating quill; and
an elongated hollow pathway structure defining a continuous inner surface for transport of elongated materials therein, the inner surface having non-ferrous material in at least one zone that is subjected to a relatively higher wear rate.

13. The system of claim 12, the inner surface in the zone contains at least one non-ferrous material and other portions of the pathway contain at least one ferrous material.

14. The system of claim 13, the elongated hollow pathway structure includes a tubular laying head pipe.

15. The system of claim 12, the zone non-ferrous material laterally abuts material outside the zone and forms a continuous inner surface there between.

16. The system of claim 12, the inner surface in the zone includes a non-ferrous inner layer that is captured by an outer layer.

17. The system of claim 16, the non-ferrous inner layer and the outer layer are in circumferential friction contact with each other, with the inner layer advancing axially with respect to outer layer during repetitive heating and cooling cycles of the elongated pathway structure.

18. A method for fabricating an apparatus for retention and transport of elongated materials in a rolling mill coil-forming laying head system comprising:
constructing an elongated hollow pathway structure with an inner surface including one or more non-ferrous materials in at least one zone that is subjected to a relatively higher wear rate and other materials in other portions of the structure that are subject to relatively lower wear rates.

19. The method of claim 18, further comprising constructing a portion of the pathway that defines the zone inner surface and capturing it within the elongated hollow pathway structure.

20. The method of claim 19, further comprising constructing the portion of the pathway that defines the zone inner surface nesting it within the elongated hollow pathway structure.
